(19) United States
(12) Patent Application Publication
(10) Pub. No.: US 2011/0287553 A1
(43) Pub. Date: Nov. 24, 2011

(54) BREACH OR CONTAMINATION INDICATING ARTICLE HAVING MICROCAPSULES

(75) Inventors: Noorman Bin Abu Hassan, Taman Bukit (MY); Norman W. Keane, Shah Alam (MY); Fazil Bin Shani, Puchong (MY); Dave Narasimhan, Flemington, NJ (US)

(73) Assignee: ANSELL LIMITED, Richmond (AU)

(21) Appl. No.: 13/025,534

(22) Filed: Feb. 11, 2011

Related U.S. Application Data
(60) Provisional application No. 61/346,634, filed on May 20, 2010.

(51) Int. Cl. G01N 21/75; B32B 37/18

(52) U.S. Cl. 436/164; 422/425; 156/60

(57) ABSTRACT

Provided among other things are breach or contamination indicating elastomeric articles for indicating a breach or contamination by a selected chemical or group of chemicals, the article having an exterior and interior and comprising: (1) an indicating layer that comprises (a) a carrier polymer, and (b) a plurality of microcapsules wherein each microcapsule comprises a dye and a shell, wherein the plurality of microcapsules is dispersed in the carrier polymer and the polymer shell releases the dye in the presence of the selected chemical(s); and (2) an elastomeric layer selected to resist permeation by the selected chemical(s), which resistant layer is to the interior or exterior side of the indicating layer.

This application claims the priority of U.S. Application No. 61/346,634 (“Breach Indicating Article Having Microcapsules”), filed May 20, 2010.

The present application relates generally to protective articles such as gloves and other wearable items that provide an indication of a chemical and/or mechanical breach of the article's protective surface.

Many workers come into contact with hazardous or pathogenic materials for which protection is desired. For example, industrial workers often come in contact with hazardous chemicals, including organic solvents, acids and bases. While permeation rates are known for various latex material protective compositions under laboratory testing conditions, a worker may not know when there is a chemical permeation occurring within the protective article during use—especially since failure of the protective wear depends on the amount, concentration or type of the contacted chemical and the thickness of the protective product.

It is known in the art that various types of articles can be used to protect individuals from these various hazardous materials. For example, gloves can be provided which protect an individual's hands and/or arms, and condoms can be provided which protect and individual's genitalia and body cavities. Such articles, however, can be compromised due to, for example, chemical permeation, punctures, partial thickness cuts, and the like. Protective articles that provide an indication that a breach of this type has occurred allow the user to remove the article to limit or prevent exposure.

One effort in this direction is believed to provide a laminate of an inner layer and outer layer, where the inner layer has an acid/base indicated blended therein for undergoing a color change upon contact with an acid or an alkali. Another effort is believed to use a bi-layer glove with a translucent outer layer and a contrasting colored inner layer, with an air-free zone between the layers. The inner layer may also include a chemical which changes color in the presence of oxygen, or a dye which is wetted by any aqueous liquid. Oxygen or aqueous liquid would reach the dye via a puncture or leak.

Another system is believed to use an air-sensitive rupture-indicating three layer system in a condom. The condom has two elastomeric layers and a middle layer of colorless, air-sensitive dye that changes color when exposed to air due to rupture of an elastomeric layer of the condom.

A further system is believed to have two layers sandwiching a layer of protective solution (e.g., an antimicrobial agent), which may release when the protective covering becomes punctured or torn. The solution may also contain a dye for visual indication of breach.

Another system uses an indicating material (for acids), such as a tautomeric dye, can be provided in a coating or incorporated in the surface of protective safety apparel. Such a dye undergoes a color change on exposure to strong acid-base atmospheres. The coating can be in the form of solvent solutions, aqueous emulsions, plastisols and other coating compositions forming discontinuous films containing the dyes.

Another device includes a pad that carries a reagent or reagent system that responds to contact with contamination and produces a visible indication. The reagent or reagent system may be carried in microcapsules. The pad is not part of the glove is merely affixed to it.

Another system has a fabric or membrane with microencapsulated indicating coating. A material can be coated with or incorporate microcapsules, especially a first type of microcapsule containing an indicator dye, a second type containing one component of a binary chemical agent, and a third type containing the other component of the chemical agent. A structural violation of the membrane also violates the capsules, causing the release of the indicator dye, as well as the two component system, which initiates a chemical reaction that widens the indication beyond the site of the initial breach.

Yet another system provides a breach monitoring system for use with non-conductive hazardous materials. An electrical conductivity monitor is connected (i) to a conducting outer glove surface and (ii) to the user's skin (made electrically conductive by a cream or by perspiration) and the monitor detects flow of electrical current when the glove has a breach.

Another system has gloves and condoms made from an outer latex layer and an inner latex layer, with an anhydrous material between these two layers. The anhydrous material turns from colorless to colored upon contact with, for example, water, blood, or bodily fluids.

Another system has a glove has an inner layer and outer layer with pigments embedded at the interface between the layers. There are linkages between the inner and outer layers. The inner and outer layers have different colors and the pigments are preferred to be fluorescent. Upon breach, the pigments are said to be exposed to a light source and reflect light and the layers are said to show contrasting colors.

Another system has a glove with visual indicator to remind the user to change glove. Warning indicators, such as ink, can be activated by UV, visible light, temperature change, air, exposure to oxidizers, pH change, and chemical reactions. The ink can be added into the glove dipping compound. A color change ink indicates to the wearer when it is time to change gloves.

Another system has a visual spill indicating composition comprising an indicating dye and an encapsulating material. Such a composition is used to detect organic substances. The composition may be included in a packet and contain an absorbent.

There is a continuing need in the art for improved indicating articles which protect users from hazardous materials.

### SUMMARY

Provided for example are breach or contamination indicating elastomeric articles for indicating a breach or contamination by a selected chemical or group of chemicals, the article having an exterior and interior and comprising: (1) an indicating layer that comprises (a) a carrier polymer, and (b) a plurality of microcapsules wherein each microcapsule comprises a dye and a shell, wherein the plurality of microcapsules is dispersed in the carrier polymer and the polymer shell releases the dye in the presence of the selected chemical(s); and (2) an elastomeric layer selected to resist permeation by the selected chemical(s), which resistant layer is to the interior or exterior side of the indicating layer. In certain embodiments the carrier polymer layer is sufficiently permeable to the selected chemical(s) to allow transmission of the selected chemical(s) within the carrier polymer layer to expand the indication area from the area immediately about the breach or contamination. Generally, the resistant elastomeric layer and/or the indicating layer are sufficiently translucent or transparent as needed so that a user of the article can observe from the exterior of the article a visual change caused by a release of dye. If there is a resistant layer exterior to the indicating layer then the article can be deemed a breach indicating article, and if not, then the article has no substantial exterior resistant layer (defined below) and the article can be deemed a contamination indicating article.

Provided for example are indicating protective elastomeric articles that, in one embodiment, comprise: an outer elastomeric layer and an indicating layer comprising a carrier polymer, and a plurality of microcapsules comprising a dye and a shell, wherein the plurality of microcapsules is dispersed in the carrier polymer and each of the microcapsules comprises a polymer shell that releases the dye in the presence of a appropriate breached fluid. The outer layer is protective as needed, for example, to provide chemical resistance, detection of chemotherapy drugs, barrier protection from bodily fluids and the like. The outer layer and as needed the indicating layer can be sufficiently translucent or transparent to facilitate the detection of the release of dye, e.g., change in color, loss of color, change of tone, or the like. The indicating layer can be sufficiently permeable to the breached fluid to expand the area that is visually detectable. The article can be in the form of, for example, a medical glove, an industrial glove, a condom, protective boots, protective forearm covers, work pads, or the like. The polymer shell of the microcapsules can be selectively soluble as needed for particular applications. For chemical resistance, the polymer shell can be soluble in one or more organic solvents and/or at acidic and/or alkaline pH.

In a detailed aspect, a chemical breach or contamination indicating glove or protective article can be provided with an outer elastomeric layer that can provide chemical resistance or other desired protection. Generally, if present, the outer elastomeric layer is sufficiently transparent or translucent so that the released dye indication can be readily viewed by the user and prompt action may be taken. An indicating inner layer is in one embodiment provided below the resistant layer. In another, embodiment the indicating layer is exterior to the resistant layer and there is no substantial resistant layer between the indicating layer and the outside of the article. By “no substantial resistant layer” it is meant that the permeation breakthrough time with respect to one of the selected chemicals is less than for the resistant layer. By “no substantial resistant layer by thickness” it is meant that the thickness of any relevant non-substantial layers is about 1 mil or less, or about 0.5 mil or less (or less than about any or 1/10 mil point from 1 to 0.5). In such non-substantial layers can have a polymer composition that is less resistant per mil thickness than the polymer composition of the resistant layer. In some embodiments, a non-substantial layer can be of polyurethane or foamed polyurethane. Any embodiment that is described herein as having “no substantial resistant layer” can have this feature substituted with “no substantial resistant layer by thickness.”

As desired, an inner skin-contacting layer is provided below the indicating layer and resistant layer. In the breach indicating configuration, this inner skin-contacting layer can provide the same chemical resistance or other desired protection as the outer layer, which can then protect the wearer when a breach has taken place, thereby preventing exposure of the user to the breached chemical or fluid. Alternatively, or in addition, the inner layer can be treated to facilitate donning, manage moisture, or both. For example, the skin-contacting inner layer can be chlorinated, foamed, flocked, a combination thereof, or the like. An inner layer can comprise a silicone emulsion or a polymer coating. An inner layer can comprise a foamed or non-foamed adhesively-bonded cotton or rayon flock, or other fabric. The article can comprise, for example, outer resistant layer(s), an indicator layer, inner resistant layer(s) and a layer adapted for ease of donning, moisture control, or the like.

The indicating layer comprises microcapsules that carry an indicating dye within a shell or wall. The shells or walls of the microcapsule are selected from materials that dissolve or disintegrate or otherwise break down when contacted by the target chemical or fluid that might permeates by chemical damage or otherwise breaches by mechanical damage through the outer resistant layer. Upon contact with the breaching or contaminating fluid, the shells or walls release the dye contained within the microcapsule, providing an indication of breach of the outer layer. The microcapsules are contained or dispersed in the indicating layer, which has a carrier polymer. The carrier polymer layer is sufficiently permeable to the breached chemical or fluid to allow an expanded area of microcapsule disruption after the first microcapsule is disrupted. The carrier polymer layer may be, for example, substantially chemically non-resistant to the breached chemical from the outer layer, in the form of an open-celled foam of a chemically resistant polymer, or otherwise provide channels for fluid flow (such as capillary flow). The breached chemical reaches microcapsules and causes a dye indication. For example, an open-celled foamed elastomer of chemically resistant polymer can permit permeation of the breached chemical from the outer layer to the microcapsules containing indicating dye. Or, for example, a non-crosslinked polymer can permit permeation of the breached chemical from the outer layer to at least one shell thereby releasing dye.

The indicating layer can be bonded to the resistant layer and, if present, an inner layer, thereby transferring stress between the layers. Upon bonding, or making the carrier polymer integral with the outer layer and/or the inner layer, load transfer between the layers during the use of the glove can occur while avoiding delamination. The carrier polymer may be a cross-linkable polymer or a non-cross linking polymer so long as it meets the permeation needs to provide timely indication. In general, a cross-linkable polymer transfers load more readily as compared to a non-cross linkable polymer, which is generally in the form of a high viscosity solid.

The manufacturing process of an indicating glove can have the following steps. A former, for example in the shape of a human hand, is (if needed to coagulate a given polymer) first dipped in a coagulant such as calcium nitrate and then is dipped in an aqueous latex emulsion of a polymer, such as a chemically resistant polymer. The composition of the chemically resistant polymer can be chosen according to the protection needs when a specific chemical is to be handled by the user. A Chemical Resistance Guide, such as one found at www.ansellpro.com/download/ Ansell_{—}8thEditionChemicalResistanceGuide.pdf, which details protection capability of various polymers and provides data on chemical permeation rates and is incorporated by reference, can be used to make polymer selections. The thickness of the resistant (protective) layer of the glove may be built up by several dips with or without additional use of coagulant. The former at this stage has a coagulated latex layer, which is next dipped into carrier polymer (e.g., a latex) with microcapsules that contain the indicating dye to form the indicating layer. The aqueous carrier polymer has to have sufficient fluidity so that the microcapsules can be dispersed throughout the breach indicating layer. The carrier polymer layer may be resistant to the chemical being detected or readily attacked or dissolved by the chemical. When the carrier polymer is resistant to the chemical being detected, the indicating layer can be formed as open-celled foam, or the carrier layer may otherwise promote fluid flow. An exemplary process for forming an open-cell foam is provided in U.S. Pat. No. 7,048,884 (Woodford et al.), which is incorporated by reference herein in its entirety, which details formation of an open-celled foam through the use of a volume of air bubbles that contact each other during the curing step. Should an resistant inner layer be desired, the former with the coagulated latex layer and indicating layer is dipped in a coagulant and further dipped in a chemically resistant aqueous latex polymer similar to the first dipped outer layer. The entire configuration can be heated to a temperature—time cycle to cure all the layers forming the integral indicating glove.

In embodiments, especially where there is no substantial outer protective layer, it can be useful to apply the microcapsules to the exterior side of the indicating layer, where they can respond more rapidly to breaching or contaminating chemicals. For example, the microcapsules can be applied by selective dipping—whereby for example a layer is a product of two or more dipping steps with or without the microcapsules. Or, the microcapsules can be applied in a very thin layer adapted to be thinner than the size of the microcapsules.

The carrier polymer in the indicating layer can be selected from a Chemical Resistance Guide, such as the one found at www.ansellpro.com/download/Ansell_{—}8thEditionChemicalResistanceGuide.pdf, to identify polymers that have low chemical resistance to the chemical being detected. A terpolymer, which is non-cross linked, is a useful carrier polymer in the indicating layer. For example, a polyurethane terpolymer can be used. Data for polyurethane is available at http://k-mac-plastics.com/data %20sheets/polyurethane_chemical_resistance.htm.

The microcapsules have a shell or wall that contains the indicating dye. The walls release the dye upon contact with the breached chemical or fluid, by for example, dissolution, rupture, degradation, or other attack. Since microcapsules are generally made with a two-phase immiscible system, the composition of the capsule wall can be chosen according to the chemical(s) for which an indication is sought. The wall composition can be the same as that of the chemically non-resistant polymer of the carrier. Gelatin has been found to be having sufficient solubility in a number of solvents and chemicals and is suited as a microcapsule wall. Other polymers known in the encapsulation art, such as those used for enteric coatings, such as Eudragit L30D (disruption in base), Eudragit L30D (disruption in base), Eudragit L30D (disruption in base) or Eudragit E (disruption in acid), can be used. Further description of enteric polymers can be found in Tarcha, Polymers for Controlled Drug Delivery, CRC Press, 1991, pp. 39-67, which is incorporated by reference in its entirety. Upon contact with chemical solvents, acids, bases, chemotherapy drugs, and/or the like, the microcapsules will dissolve or rupture or otherwise collapse. In some embodiments, the carrier polymer is a non-crosslinkable polymer, such as a polyurethane terpolymer. In other embodiments, the carrier polymer can be a foamed material, such as foamed rubber, that can be either cross-linkable or non-crosslinkable.

The microencapsulated dye can be encapsulated in a polymeric microcapsule. The microcapsule can comprise a core comprising the dye in admixture with a hardening agent (such as a fatty acid ester) and a shell comprising a transparent biocompatible polymer.

In one embodiment, the core of the microcapsule comprises an FDA-approved dye in admixture with isopropyl myristate and the shell of the microcapsule comprises gelatin.

The microcapsules can be soluble in one or more organic solvents, but can also soluble at different pH ranges or at fairly specific pHs. Using the chemical indicating glove, a chemical breach causes the microcapsules in the indicating inner layer to rupture or dissolve, releasing the encapsulated dye, which can be visually detected as a loss of color seen through the chemical resistant outer elastomeric layer. This allows the breach to be immediately detected, allowing the user to remove the damaged glove and don a new glove.

Another embodiment provides a contamination indicating elastomeric article for indicating a contamination by a selected chemical or group of chemicals comprising: (1) a indicating layer comprising (a) a carrier polymer, and (b) a plurality of microcapsules wherein each microcapsule comprises a dye and a shell, wherein the plurality of microcapsules is dispersed in the carrier polymer and the polymer shell releases the dye in the presence of the selected chemical(s), wherein (i) the polymer composition of the indicating layer is selected to resist permeation by the selected chemical(s), and (ii) the indicating layer is the only layer adapted to provide substantial resistance to the selected chemical(s). The indicating layer is generally sufficiently translucent or transparent so that a user of the article can observe a visual change caused by a release of dye.

### DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only illustrative embodiments of this invention and are therefore not to be considered limiting of its scope, for the invention may admit to other equally effective embodiments.

FIG. 1 depicts a section of an article in accordance with various aspects of the present invention;

FIG. 2A is a photograph of a glove in an unbreached state and FIG. 2B is a photograph of a glove in a breached state;

FIG. 3 is a scanning electron microscope micrograph showing a cross-section of an exemplary glove;

FIGS. 4A-4D show a section of an article in accordance with various aspects of the present invention; and

FIGS. 5A-5D show a section of an article in accordance with various aspects of the present invention.

To facilitate understanding, identical reference numerals have been used, where possible, to designate comparable elements that are common to the figures. The figures are not drawn to scale and may be simplified for clarity. It is contemplated that elements and features of one embodiment may be beneficially incorporated in other embodiments without further recitation.

### DETAILED DESCRIPTION

In many embodiments, the articles comprise a resistant layer and an indicating layer comprising a carrier polymer, and a plurality of microcapsules comprising a dye and a shell, wherein the plurality of microcapsules is dispersed in the carrier polymer and the shell releases the dye in the presence of the contaminant. In some embodiments, the microcapsules provide an indication of damage by sharp or blunt impact or by abrasion. Generally, the carrier polymer is more permeable to the breached fluid than the outer layer sufficiently to provide a useful visual indication. That is, the breached fluid permeates the carrier polymer in a timely manner to reach the microcapsules so that the size of the indication is useful to alert the wearer to the breach. The sensitivity of breach detection can thus be tailored. For detection on the level of ppm, then, a highly permeably carrier layer can be used, or a strong dye indication per microcapsule release can be used. For applications where a higher level of breach can be tolerated, then the carrier layer or dye strength can be chosen accordingly. For chemical resistance, the shell can be soluble in one or more organic solvents and/or at acidic and/or alkaline pH. Reference to “chemical resistance” and “chemically resistant” means that an elastomer barrier layer offers a desired degradation rating, permeation rate, and/or permeation breakthrough time with respect to a particular chemical. A “breached fluid,” “contaminating fluid,” “breached chemical” or “contaminating chemical” refers to material that makes it way, i.e., permeates, the indicating layer.

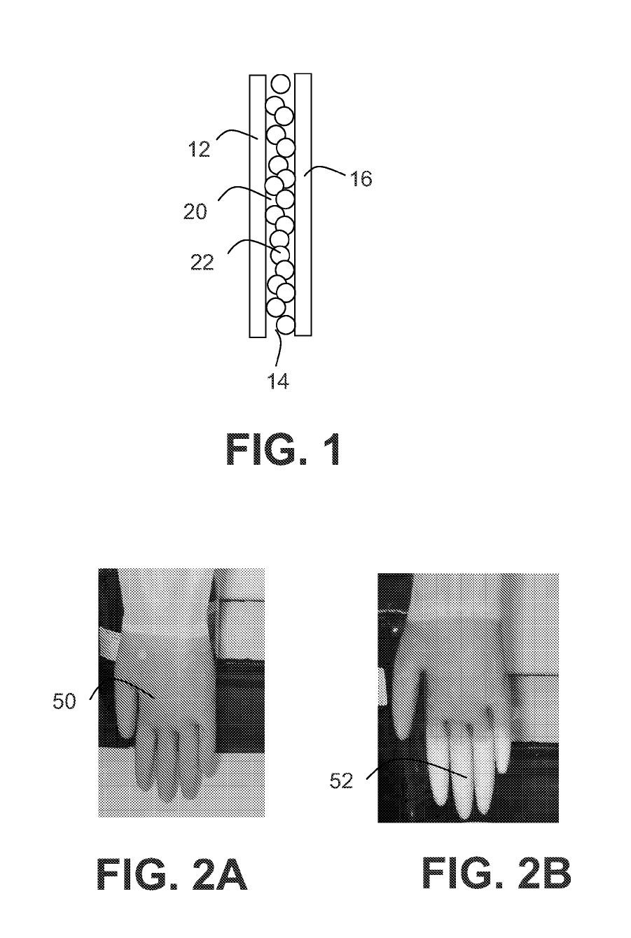

FIG. 1 depicts a section of article in accordance with an aspect of the present invention. The article can be any article that provides protection from chemical(s), such as a chemically resistant industrial glove. The illustrated section of article has three layers 12, 14, and 16. The layers can be formed from multiple layering applications, or otherwise have sub-layers. In certain embodiments, layer 16 can be omitted. The layers 12 and 14 can be manufactured using dipping methods generally known to those skilled in the art. The thickness of each of the layers, and thus of the article in whole, will generally be dictated by its end use. Layer 16 can also be formed by dipping, but can be supplied as a substrate of a knitted or woven or other fiber-containing structure.

In one embodiment, outer layer 12 forms the outside surface of the article and provides a chemical resistant barrier to the user. Outer layer 12 can be formed with an elastomeric material. In accordance with one embodiment of the present invention, outer layer 12 is a nitrile-based latex. In accordance with embodiments of the present invention, outer layer 12 is formed with latex selected from the group consisting of carboxylated acrylonitrile butadiene, non-carboxylated acrylonitrile butadiene, butyl latex, polychloroprene, natural rubber, synthetic polyisoprene, polyurethane, and combinations thereof. In accordance with an embodiment of the present invention, outer resistant layer 12, or another resistant layer of the invention, has a thickness in the range of about 1 to 50 mil (25.4 to 1270 μm), although different thicknesses can be provided based on the chemical properties desired. For example, the lower end of thickness can be about 1 mil, and to a higher end can be about 50 mil (or a range therebetween such as from about any or integer mil point in the range (e.g., 1, 2) to about another integer mil point in the range). Outer layer 12 can be provided with an additional dip coating for foamed or roughened textures suitable for its intended use, such as for enhanced gripping.

Inner layer 16 forms the inside surface of the article, and is therefore the skin-contacting layer. This inner layer 16 can be chemically resistant to maintain skin protection upon breach of the outer layer 12. Inner layer 16 can be formed with an elastomeric material, and may be transparent or translucent. In accordance with one embodiment of the present invention, inner layer 16 is formed with a nitrile-based latex. In accordance with further embodiments of the present invention, inner layer 16 is formed from latex selected from the group consisting of carboxylated acrylonitrile butadiene, non-carboxylated acrylonitrile butadiene, butyl latex, polychloroprene, natural rubber, synthetic polyisoprene, and polyurethane. In accordance with an embodiment of the present invention, inner layer 16, or another inner layer not intended to be the primary resistant layer, can have a thickness of about 2 to 6 mil (50.8 to 152.4 μm), although different thicknesses can be provided based on the properties desired. For example, the lower end of thickness can be about 1 mil, and a higher end of thickness can be about 10 mil (or a range therebetween such as from about any or integer mil point in the range to about another integer mil point in the range).

Inner layer 16 can be provided with a surface that facilitates donning For example, the inner layer 16 can be chlorinated. The inner layer can also be provided with a silicone emulsion or a polymer coating, as described in U.S. Pat. No. 5,570,475 to Nile, hereby incorporated by reference. The inner layer can also be provided with high density polyethylene particles, wax, or both, in accordance with U.S. Pat. No. 6,378,137 to Hassan, U.S. Pat. No. 6,709,725 to Lai, and U.S. Pat. No. 5,570,475 to Nile referenced above, all of which are hereby incorporated by reference in their entireties. In accordance with further embodiments of the present invention, inner layer 16 can be foamed with closed cells providing inner chemical resistant layer protecting the user in the event of a breach of the outer layer. Inner layer 16 can also be provided with an inner surface that manages moisture. Accordingly, the inner layer 16 can further be foamed or unfoamed and comprise an adhesively-bonded cotton or rayon flock. Multiple sub-layers of layer 16 can be used to provide multiple functions.

Middle layer 14 is an indicating layer positioned under outer layer 12 (relative to the prospective direction of chemical breach). The indicating layer 14 comprises a carrier polymer 20, that can be transparent or translucent, and a plurality of microcapsules 22 containing a colored dye. Microcapsules 22 may be dispersed in the carrier polymer 20 at any desired density. In certain embodiments the forming composition for the dye-containing layer comprises 10% or of microcapsules, and/or 80% or less of microcapsules (or a range therebetween, such as from about any or 5 percent point in the range (e.g., 10, 15) to another 5 percent point in the range).

Carrier polymer 20 is of sufficient viscosity and/or porosity and/or permeability that the microcapsules can be dispersed in it during manufacturing, while also allowing the encapsulated dye to permeate throughout the middle layer upon rupture of the microcapsules after it is solidified as finished product through coagulation and drying processes. The carrier polymer is preferably a terpolymer that is non-crosslinked. An exemplary terpolymer is a polyurethane terpolymer. In other embodiments, the carrier polymer can be a foamed material, such as foamed polyurethane, foamed natural or synthetic elastomeric latexes. An embodiment uses the same latex source as layers 12 and/or 16 in a foamed state. In accordance with one embodiment of the present invention, layer 14, or another indicating layer of the invention, has a thickness in the range of 1 to 10 mil (25.4 to 254 μm), or 1 to 5 mil (25.4 to 127 μm), or 1.6 to 3.0 mil (40.6 to 76.2 μm), or about 2 mil (50.8 μm). For example, the lower end of thickness can be about 0.5 mil, and a higher end of thickness can be about 10 mil (or a range therebetween such as from about any or 1/10 mil point in the range (e.g., 0.5, 0.6) to about another 1/10 mil point in the range).

Microcapsules 22 can be manufactured by any method known in the art. For example, U.S. Pat. No. 5,066,436 to Komen et al., hereby incorporated by reference in its entirety, discloses processes for encapsulation of water-soluble bioactive substances in biocompatible polymers using fatty acid esters as hardening agents. The encapsulating shell material is preferably a transparent biocompatible polymer and will generally depend on the end use of the article. For example, a polymer soluble in organic solvents (e.g., toluene, ketones, butyl acetates, cyclohexane, aromatic solvents, alcohols, etc.) can be used for industrial gloves, as can a material that is soluble at different pH ranges (e.g., acid soluble or alkali soluble) or at fairly specific pHs (e.g., enteric polymers). Gelatin has been found to be a suitable encapsulating shell material having at least some of the above properties. Gelatin is a clear, non-pigmented protein often found in pharmaceutical capsules and is soluble in numerous organic solvents, as well as strong acidity and alkalinity. Without being bound to any particular theory, it is believed that the carrier polymer 20 will bind and carry gelatin-coated microcapsules in their original spherical shape even when heating at nitrile-curing temperatures of up to about 140° C. Suitable gelatin microcapsules can be obtained from Lipo Technologies Inc. (Vandalia, Ohio) under the tradename Lipocapsule™

The inner phase of microcapsules 22 contains a colored dye and may also contain a hydrophobic core material (such as a hardening agent). In one embodiment, the hydrophobic core material is a fatty acid ester. Suitable fatty acid esters include ethyl and isopropyl esters of straight chain fatty acids having 12-18 carbon atoms, such as ethyl stearate, isopropyl stearate, ethyl oleate and, preferably, isopropyl myristate and isopropyl palmitate.

Any colored dye or dyes can be used in the core of the microcapsules as long as they are capable of leaching out of the microencapsulated beads upon collapse. Preferably, the dye is selected from those approved by the FDA for external and/or internal use. Suitable dyes include D & C Yellow #11, D & C Red #17, FD & C blue #1, and FD & C Green 3. The amount of dye in the microencapsulated beads can be tailored for particular needs of detection. In one embodiment, the colored dye is present in an amount in the range of 0.1 to 0.3% by weight of the beads, for pronounced impact on the color intensity of the indicator layer.

The microcapsules can have a diameter less than about 50 microns, or diameter less than about 20 microns. The microcapsules can have a diameter more than about 5 microns, in a range between the boundaries described herein (such as from about any integer micron point in the range to another integer micron point in the range). In one embodiment of the present invention, the microencapsulated beads 22 have a shell thickness of about 2 microns and a core thickness of about 18 microns. Such a size ensures that the microcapsules total diameter (about 20 microns) will be bound by the carrier polymer 20 within layer 14. The term “microcapsules” refers to capsules small enough to provide a functional distribution within what is generally a relatively thin indicating layer. In many configurations, the smaller the bead, the faster the indicator bleeds in the indicator layer.

A breach of the protective article occurs when at least outer layer 12 layer is permeated by a solvent, acid or base (i.e., chemical breach) or other fluid from which protection is required. A breach can also be created by an instrument or other object that punctures or tears at least the outer layer 12 layer (i.e., mechanical breach). In one embodiment of the present invention, a glove of outer layer 12 with potential thin spots or tiny pinholes can also be permeated by chemicals that allow abrupt color change to the indicator layer 14. In the embodiment illustrated in FIG. 2, when a chemical breach occurs, microcapsules 22 located in indicating layer 14 come in contact with the chemical(s) and rupture or dissolve or otherwise breakdown. In an unbreached state as shown in FIG. 2A, the gloves have a visual color 50 in general accordance with the dye being sequestered in the microcapsules. Upon breach, the colored dye inside microcapsules 22 is released and its color no longer makes a notable visual impression. As a result as shown in FIG. 2B, a white or colorless area 52 is seen through transparent or translucent outer layer 12 in the finger areas where breach has occurred. Capillary action between glove layers may assist in spreading the white patch or colorless spot beyond the site of the initial breach. This capillary effect facilitates breach rapid breach detection, allowing the user to remove the damaged glove and don a new glove. In other embodiments, the dye may be sequestered in the microcapsules so as to reduce its visual impact, and have greater impact upon release.

In one embodiment consistent with FIG. 2, lower end of thickness for the article (or the polymer layers thereof) can be about 0.1 mm or 4 mil, and a higher end of thickness can be about 0.61 mm or 24 mil (or a range therebetween, such as from about any or integer mil point in the range to another integer mil point in the range).

As one of skill in the art will recognize, the point of breach of an industrial glove is generally reached upon solvent exposure near the outer layer's permeation breakthrough time, which is generally dependent on the outer layer's thickness and degree of chemical resistance. However, estimations of breakthrough time measured on unflexed gloves may be unreliable because flexing is known to affect breakthrough time. The use of an indicating layer overcomes this problem since a breach of the glove can be immediately detected, whether in the flexed or unflexed state. Moreover, a real breakthrough time at the point of actual nitrile film solvent exposure is directly dependent on the measured spots exposed i.e. film surface condition of the glove which is not even the case for analytical breakthrough time measured as per EN 374-3 testing.

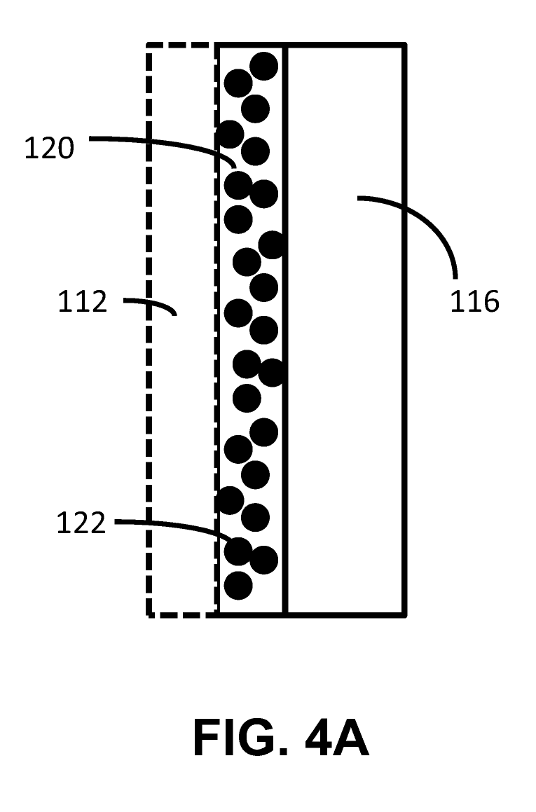

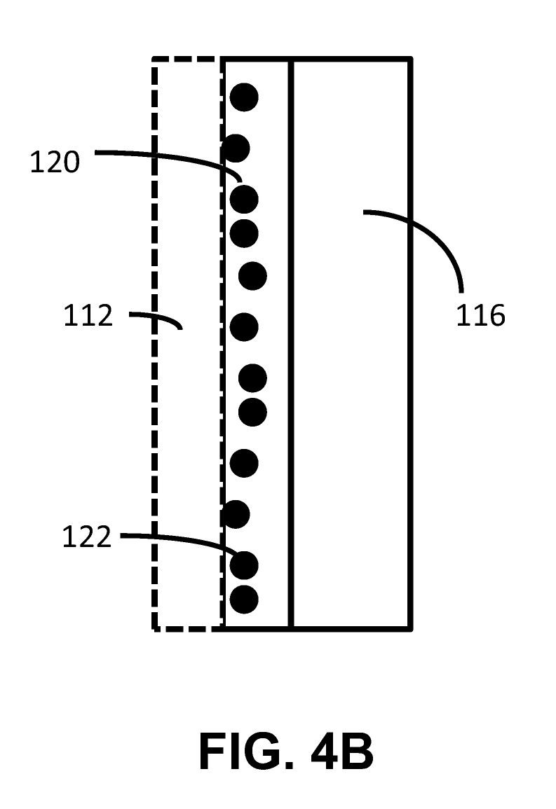

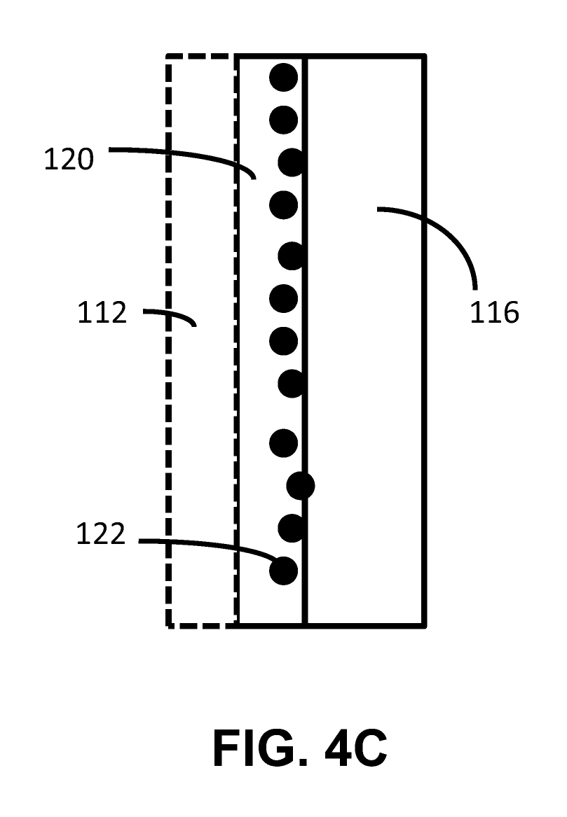

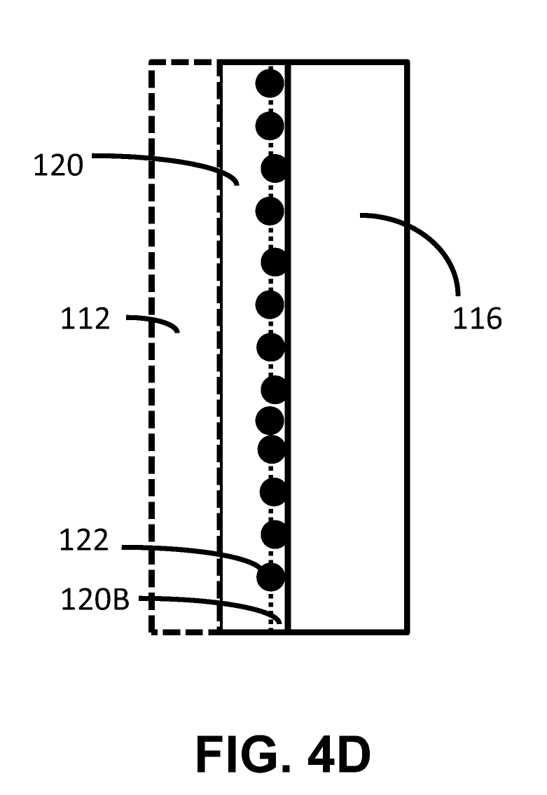

Illustrated in FIG. 4 is an embodiment where the indicating layer is exterior, or, if there is a further exterior layer (or layers), these make only an insubstantial contribution to slowing permeation by the selected chemicals. The outer layer 112, if present, is of a thickness or material selected so that it not a substantial resistant layer (as defined above). This embodiment is designed to give rapid notification of contamination. As such, layer 112 should not provide a substantial delay. However, such a layer may be present (of the correct material or thickness) to tune the notification time or improve the exterior texture of the glove. Layer 120 is an indicating layer; shells 122 are dye-filled microcapsules (as described above); layer 116 is a resistant layer (as described above). As indicated in FIGS. 4B, 4C and 4D and discussed above, the localization of the microcapsules 122 can be biased to the exterior or interior of the indicating layer. Such positioning, with or without a layer 112, can contribute to tuning the notification time. Layer 116 provides the user with time to discard and replace the protective article after a contamination is detected. On layer 120 providing an indication of contamination, the protective article might, for example, be replaced with a more protective article, and a decontamination procedure may be triggered. In FIG. 4D, the shells 122 are placed by a sequential dip forming subpart 120B of layer 120. Subpart 120B can be formed of chemically resistant polymer, since the remaining part of layer 120 provides diffusion of the chemical.

In this embodiment, as in the others described in the specification, there can be additional layers that do not materially affect the notification function. Also, a given layer may be the result of multiple dipping/coating steps—and the polymer composition used in the dipping steps may vary.

Outer layer 112 or 212 (discussed below) can be formed of a relatively breathable polymer, such as polyurethane or foamed polyurethane. The outer layer can be adapted to be abrasion resistant but not chemically resistant. In embodiments such as where the glove is a splashglove—i.e., a glove intended to give rapid notice of chemical exposure—the material of the outer layer can be tuned to transmit a chemical or class of chemicals through to the indicating layer.

In one embodiment consistent with FIG. 4, the lower end of thickness for layer 120 can be about 0.5 mil, and a higher end of thickness can be about 3 mil (or a range therebetween, such as from any 1/10 mil point in the range to another 1/10 mil point in the range). The lower end of thickness for layer 116 can be about 2 mil, and a higher end of thickness can be about 50 mil (or a range therebetween such as from about any or 1/10 mil point in the range to about another 1/10 mm point in the range). The lower end of thickness for the article (or the polymer layers thereof) can be about 3 mil, and a higher end of thickness can be about 50 mil, or about 30 mil (or a range therebetween such as from about any or 1/10 mil point in the range to about another 1/10 mm point in the range).

A surface treatment, such as chlorination, siliconization, or a polymer coating can be applied to the article to reduce any inherent tackiness. A polymer coating process for example laminates the surface of the glove with a thin layer of synthetic polymer, normally up to several micrometers in thickness, having a low-friction coefficient value to provide anti-tack and good slip properties, as disclosed in U.S. Pat. No. 6,709,725 to Lai et al., which discloses a natural or synthetic rubber elastomeric article having a coating layer containing a blend of a film-forming polymer and a wax. An outer layer 112 can serve to modify the surface tack that would apply with the polymer of layer 120, and can provide a substrate for an anti-tack treatment.

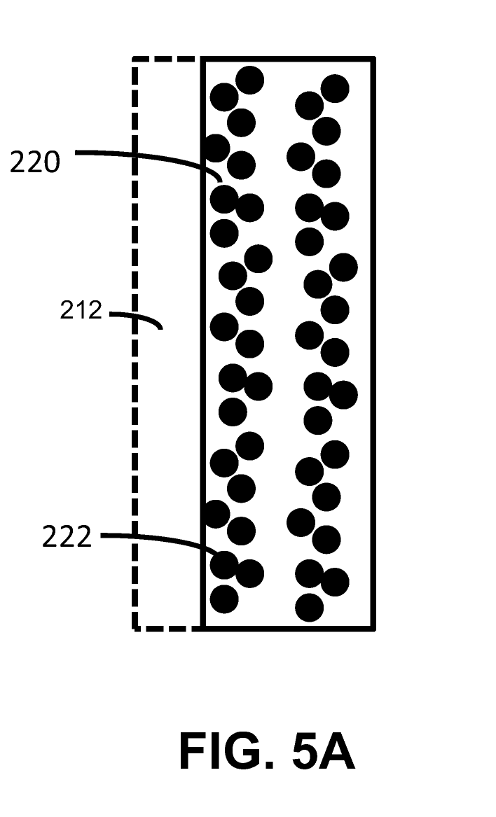

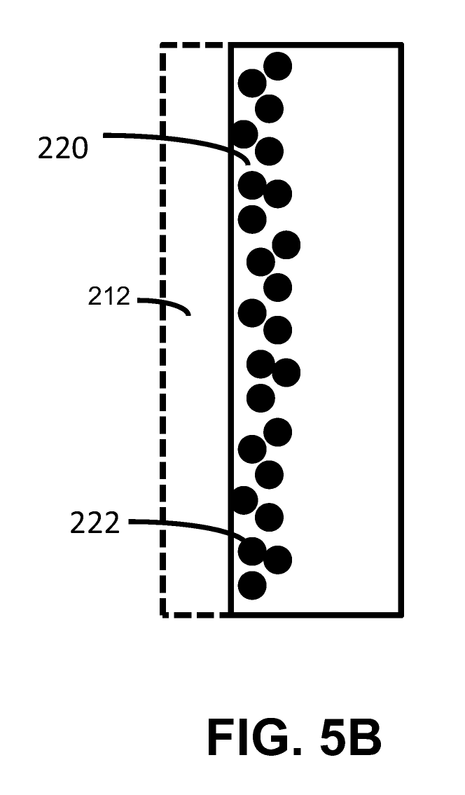

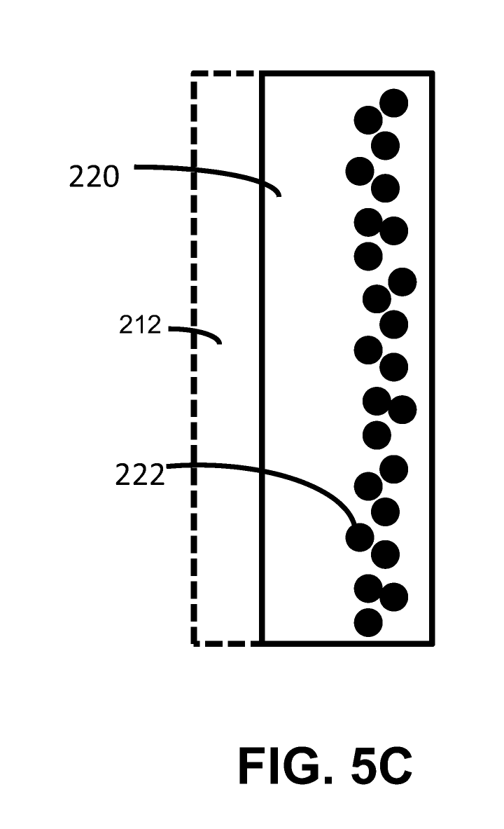

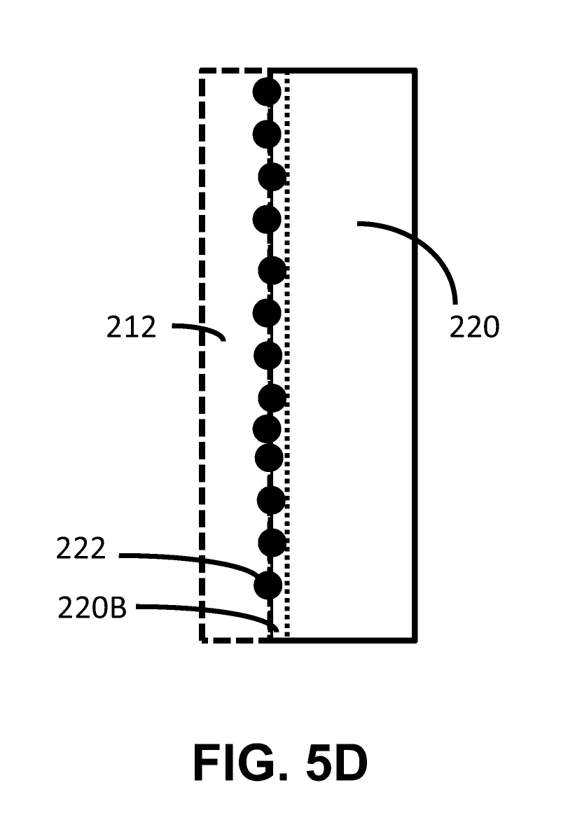

In the splash protection embodiment illustrated in FIG. 5, there is only an indicator layer 220 (among layers adapted to provide some protection). The outer layer 212, if present, is of a thickness or material selected so that it not a substantial resistant layer (as defined above). This embodiment is designed to give rapid notification of contamination. As such, layer 212 should not provide a substantial delay. However, such a layer may be present (of the correct material or thickness) to tune the notification time. As indicated in FIGS. 5B, 5C and 5D, the microcapsules can be biased (e.g., inside or outside), in there distribution in the layer. In one embodiment consistent with FIG. 5, the lower end of thickness for layer 220 can be about 0.1 mm or 4 mil, and a higher end of thickness can be about 50 mil, or about 30 mil (or a range therebetween such as from about any or 1/10 mil point in the range to about another 1/10 mm point in the range).

In this embodiment, the indicating layer is the only layer adapted to provide substantial resistance to the selected chemical(s). In general, the indicating layer provides only a relatively short period of protection, but any additional layer material provides less. A surface treatment, such as chlorination, siliconization, or a polymer coating can be applied to the article to reduce any inherent tackiness. The articles (e.g. gloves) in some embodiments do not provide significant chemical barrier protection, only splash protection, and then as signaled by the contamination indicator the article should be replaced. The embodiment can provide for thinner, more easily worked articles that nonetheless provide protection—even if requiring more frequent exchanges of the protective wear.

In this embodiment, the amount of dye can be relatively increased over that in embodiments of FIG. 1, for example via more dye per microcapsule, or more microcapsules. Generally, the indicating layer of this embodiment is formed of polymers and polymer forms that are less apt to laterally permeate the chemical(s) than may pertain for the embodiments of FIG. 1. In the embodiments of FIG. 4, more dye and generally greater resistance to permeation can also be utilized. Thus, the polymer options described above for the resistant layer can be used in the indicating layer of the FIGS. 4 and 5 embodiments. In certain embodiments, to offset the decrease in lateral diffusion of the breaching/contaminating fluid, the density of microcapsules, and/or the amount of dye per microcapsule, and/or the selection of dye is adjusted to increase the signal provided by the lysis of a microcapsule. Subpart 120B of FIG. 5D can be more permeable where an outer layer 212 is present.

Interior layers that are not adapted to provide chemical resistance, such as fabric layers, can be used in the FIG. 5 embodiments.

Specific embodiments according to the methods of the present invention will now be described in the following examples. The examples are illustrative only, and are not intended to limit the remainder of the disclosure in any way.

### Example 1

Microcapsules were tested for compatibility with various materials. The microcapsules were obtained from Lipo Technologies Inc. and had a core comprising isopropyl myristate and D & C Yellow #11, D & C Red #17 or FD & C blue #1 and a shell comprising gelatin. Five grams of microcapsules were found to fully disintegrate after 15-20 minutes in 25 ml methanol, propanol, 37% HCl, 40% NaOH and ammonia solution, but remained fully intact in water. The beads were also found to be fully compatible with coagulant materials commonly used in latex dipping procedures.

### Example 2

Dipped plate films having an outer chemical resistant elastomeric layer and inner indicating layer were prepared using the following dipping profile:

Step 1 Heat dipping plate to 60° C.

Step 2 Dip heated plate into 25% calcium nitrate coagulant heated to 60° C. Entry 25 seconds, dwell 5 seconds, exit 26 seconds.

Step 3 Dip coagulant wetted plate into nitrile latex at ambient temperature. Entry 25 seconds, dwell 5 seconds, exit 26 seconds.

Step 4 Dip nitrile coated plate into 10% calcium nitrate primer solution.

Step 5 Dry in oven for 2 min at 90° C.

Step 6 Dip into indicating compound. Entry 25 seconds, dwell 5 seconds, exit 25 seconds.

Step 7 Two stage curing at 90° C. for 15 min, 120° C. for 35 minutes.

The indicating compound was prepared by mixing 150 g HyStretch® V60 polyurethane emulsion with 300 g microcapsules of the type used in Example 1 containing D & C Yellow #11 (or a similar 1:2 ratio polyurethane emulsion to microcapsules).

Latex and coagulant formulations for preparing the outer chemical resistant layer were prepared as shown below in Tables I and II (TSR: total solid content; PHR: parts by weight per hundred parts of polymer), respectively:

TABLE I
Latex

| | | | Dry Weight | |
|---|---|---|---|---|
| Chemical | TSC (%) | PHR | (kg) | Wet Weight (kg) |
| Synthomer 6617 | 44 | 100 | 1100 | 2500 |
| NBR | | | | |
| Sulfur | 60 | 1.00 | 11.00 | 18.33 |
| Dispersion | | | | |
| Zinc Oxide | 50 | 3.5 | 38.50 | 77.00 |
| Dispersion | | | | |
| ZDEC | 50 | 1.00 | 11.00 | 22.00 |
| Dispersion | | | | |
| Polymer | 11.3 | 0.50 | 5.50 | 48.67 |
| additive | | | | |
| Stabiliser | 5 | 0.70 | 7.70 | 154.00 |
| Water | — | — | — | 42.68 |
| Total | | | 1173.70 | 2862.68 |

TABLE II
Coagulant

| | | | Dry | Wet |
|---|---|---|---|---|
| | | | Weight | Weight |
| Chemical | TSC (%) | Part | (kg) | (kg) |
| DipCal ™ | 88 | 25 | 28.41 | 710.23 |
| Triton X- | 100 | 0.005 | 0.0005 | 0.13 |
| 100 | | | | |
| Water | 100 | — | 71.59 | 1789.65 |
| Total | | | 100 | 2500 |

The films had no patches or cracks and were uniform in color. The films were tested for breach detection capability by soaking in various solvents. Following soaking in ethanol, methanol, and propanol for 18 hours, the indicating layer changed from yellow to transparent. Following soaking in cyclohexanone, propanol, and toluene for 4 hours, the indicating layer changed from yellow to transparent. Portions which did not contact alcohol remained yellow. A different encapsulation polymer might be chosen to detect aqueous base since in 50% NaOH the indicating layer did not change color.

### Example 3

A breach-indicating glove having an outer chemical resistant elastomeric layer and inner indicating layer were prepared with the latex and coagulant formulation described in Example 2 (or similar thereto) using the following dipping profile:

Step 1 Heat former to 60° C.

Step 2 Dip heated former into 25% calcium nitrate coagulant heated to 50-55° C. Entry 25 seconds, dwell 5 seconds, exit 26 seconds.

Step 3 Dry at ambient temperature for 2 minutes.

Step 4 Dip coagulant wetted former into nitrile latex at ambient temperature. Entry 25 seconds, dwell 5 seconds, exit 26 seconds.

Step 5 Dry at ambient temperature for 2 minutes.

Step 6 Dip nitrile coated former into 10% calcium nitrate primer solution.

Step 7 Dry at ambient temperature for 2 minutes.

Step 8 Dip into indicating compound. Entry 25 seconds, dwell 5 seconds, exit 25 seconds.

Step 9 Dry at ambient temperature for 5 minutes.

Step 10 Two stage curing at 90° C. for 15 min, 120° C. for 35 minutes.

Step 11 Strip gloves from former.

The indicating compound was prepared by mixing 500 g HyStretch® V60 polyurethane emulsion with 1000 g microcapsules of the type used in Example 1 containing D & C Yellow #11.

The resulting gloves had no patches or cracks and were uniform in color and visually appealing. The gloves were tested for breach detection capability by soaking in various solvents. Following soaking in ethanol, methanol, and propanol for 18 hours, the indicating layer changed from yellow to transparent. Following soaking in cyclohexanone, propanol, and toluene for 4 hours, the indicating layer changed from yellow to transparent. Portions which did not contact alcohol remained yellow. A different encapsulation polymer might be chosen to detect aqueous base since in 50% NaOH, the indicating layer did not change color.

Following soaking in acetone, toluene and methanol for 3 hours, the indicating layer changed from light green to transparent, yellowish transparent and opaque, respectively. A different encapsulation polymer might be chosen to detect more hydrophobic solvents since in n-heptane the indicating layer did not change color.

### Comparative Example 4

Dipped plate films having an outer chemical resistant elastomeric layer and inner indicating layer were prepared essentially as in Example 2, except that a crosslinkable Hauthane polyurethane emulsion was used to bind the microcapsules in the inner indicating layer.

Following soaking in toluene, hexane, and propanol for 24 hours, the indicator beads did not change color.

### Example 5

A 2-layered breach-indicating glove having an 11 mil outer chemical resistant elastomeric layer and a 2 mil indicating layer were prepared in general accordance with Examples 2 and 3. Breakthrough times based on the first detection of color change for various solvents were measured.

In the table below, examples show an average breakthrough time of gloves having an outer nitrile layer and an indicating layer. For the tested gloves, three fingers were stretched with an insert and then soaked in various chemicals. Time to the first appearance of whitish spots on the three fingers was then noted. Gloves of the same structure and comparable thicknesses were then measured in accordance with standard EN 374-3 for permeation testing. The time to color change was noted.

| | Average time to breakthrough | Permeation |
|---|---|---|
| | upon noticeable appearance | breakthrough time as |
| | of color change on glove | measured by EN 374-3 |
| Chemical | (minutes) | (minutes) |
| Acetone | 12.4 | 8.3 |
| Methanol | 8.3 | 8.3 |
| Toluene | 20.3 | 13.3 |
| Sulfuric acid 96% | 22.5 | 56.4 |

For methanol, the average time to breakthrough and the EN 374-3 permeation time were the same. For acetone and toluene, the average time to breakthrough was more than the time measured by EN 374-3. For sulfuric acid, the average time to breakthrough was much less than the time measured by EN 374-3. Permeation and breakthrough are highly sensitive to sample thickness. Testing by EN 374-3 is on a selected portion of a glove. In contrast, the use of indicating gloves as presented herein offers real time breakthrough indication in all parts of the glove.

### Example 6

A 2-layered breach-indicating glove having an 11 mil outer chemical resistant elastomeric layer made from unfoamed nitrile first layer in general accordance with Table I and a 6 mil indicating layer made with microcapsules mixed with a cross-linked foamed nitrile. Use of foamed cross-linked nitrile indicator layer resulted in a glove that changed from green to whitish spots on the unfoamed nitrile first layer on the spots exposed to acetone for 2 minutes as well as swelling of the nitrile film.

### Example 7

A 2-layered breach-indicating glove having an 11 mil outer chemical resistant elastomeric layer is made from unfoamed nitrile in general accordance with Table I and a 1 mil indicating layer made with microcapsules mixed foamed PU terpolymer, Hystretch V60. Use of foamed non-crosslinkable indicator layer results in a glove that provides indication.

### Example 8

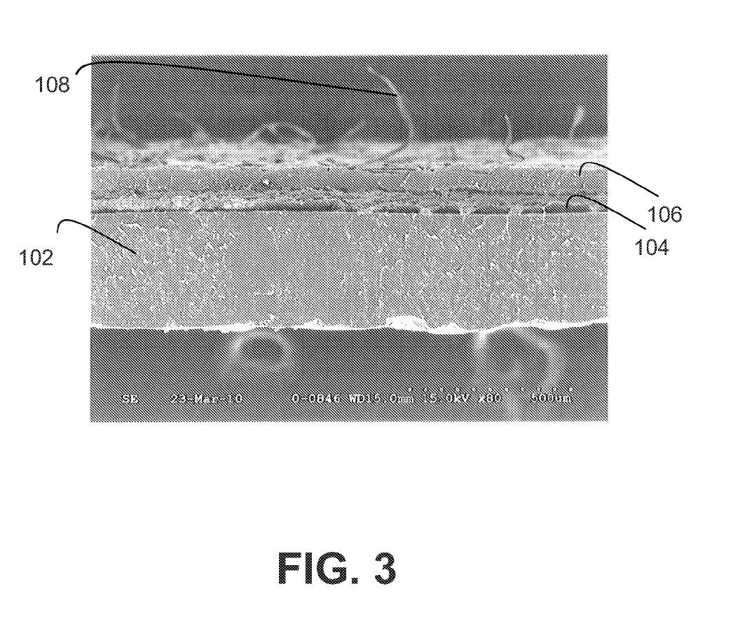

A 3-layered breach-indicating glove having an 11 mil outer chemical resistant nitrile elastomeric layer, a 2 mil indicating layer, and a 2 mil inner nitrile layer having cotton flock was prepared using standard former dipping technology. The inner nitrile layer is cotton flocked to facilitate moisture management and donning. A cross-section of the resulting glove is shown in FIG. 3, where outer layer 102 is adjacent to microcapsules 104 which is adjacent to inner layer 106 which contains cotton flock 108.

### Example 9

A 3-layered breach-indicating glove having an 11 mil outer chemical resistant elastomeric layer, a 2 mil indicating layer, and a 2 mil inner nitrile layer is prepared using standard former dipping technology as per Example 8. The inner nitrile layer is further chlorinated to facilitate donning.

This invention described herein is of a breach or contamination indicating elastomeric article and methods of forming the same. Although some embodiments have been discussed above, other implementations and applications are also within the scope of the following claims. Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

What is claimed is:

1. A breach or contamination indicating elastomeric article for indicating a breach or contamination by a selected chemical or group of chemicals, the article having an exterior and interior and comprising:
an indicating layer comprising:
a carrier polymer, and
a plurality of microcapsules wherein each microcapsule comprises a dye and a shell, wherein the plurality of microcapsules is dispersed in the carrier polymer and the polymer shell releases the dye in the presence of the selected chemical(s); and
an elastomeric layer selected to resist permeation by the selected chemical(s), which resistant layer is to the interior or exterior side of the indicating layer.

2. The article of claim 1, wherein the carrier polymer layer is sufficiently permeable to the selected chemical(s) to allow transmission of the selected chemical(s) within the carrier polymer layer to expand the indication area from the area immediately about the breach or contamination.

3. The article of claim 1 in the form of a medical glove, an industrial glove, or a condom.

4. The article of claim 1, which is a breach indicating article and is adapted for wearing by a user and comprising an additional layer interior to the indicating layer.

5. The article of claim 4, wherein the resistant layer and the interior layer each independently comprises a latex selected from the group consisting of carboxylated acrylonitrile butadiene, non-carboxylated acrylonitrile butadiene, polychloroprene, natural rubber, synthetic polyisoprene, polyurethane, and combinations thereof.

6. The article of claim 1, wherein the shell comprises gelatin.

7. The article of claim 1, wherein each of the microcapsules further comprises a hydrophobic core material.

8. The article of claim 1, wherein the article is a glove, the resistant layer is exterior to the indicating layer and comprises a nitrile-based latex, the indicating layer comprises a plurality of microcapsules dispersed in a carrier polymer comprising a polyurethane terpolymer, the microcapsules comprise a shell comprising gelatin and a core comprising isopropyl myristate and a colored dye, wherein the shell is soluble in one or more organic solvents.

9. The article of claim 1, wherein the article is a glove, the resistant layer is interior to the indicating layer and comprises a nitrile-based latex, the indicating layer comprises a plurality of microcapsules dispersed in a carrier polymer comprising a polyurethane terpolymer, the microcapsules comprise a shell comprising gelatin and a core comprising isopropyl myristate and a colored dye, wherein the shell is soluble in one or more organic solvents.

10. The article of claim 1, wherein the resistant layer is exterior to the indicating layer.

11. The article of claim 1, wherein the resistant layer is interior to the indicating layer.

12. A method of protecting a user comprising:
providing the article of claim 1, and
detecting breach or contamination of the article upon a change of color due to release of the dye from the microcapsules.

13. A method of making an indicating article, the method comprising:
providing an protective elastomeric layer; and
providing an indicating layer comprising a carrier polymer a plurality of microcapsules containing a dye, wherein the carrier polymer layer is sufficiently permeable to the selected chemical(s) to transmit the selected chemical(s) within the carrier polymer layer to expand an indication area from the area immediately about the breach.

14. A contamination indicating elastomeric article for indicating a contamination by a selected chemical or group of chemicals comprising:
a indicating layer comprising:
a carrier polymer, and
a plurality of microcapsules wherein each microcapsule comprises a dye and a shell, wherein the plurality of microcapsules is dispersed in the carrier polymer and the polymer shell releases the dye in the presence of the selected chemical(s),
wherein the polymer composition of the indicating layer is selected to resist permeation by the selected chemical(s),
and wherein the indicating layer is the only layer adapted to provide substantial resistance to the selected chemical(s).

15. The article of claim 14 in the form of a medical glove, an industrial glove, or a condom.

16. The article of claim 14, wherein the carrier polymer comprises a latex selected from the group consisting of carboxylated acrylonitrile butadiene, non-carboxylated acrylonitrile butadiene, polychloroprene, natural rubber, synthetic polyisoprene, polyurethane, or a mixture thereof.

17. The article of claim 14, wherein the article is a glove, the indicating layer comprises a nitrile-based latex, the microcapsules comprise a shell comprising gelatin and a core comprising isopropyl myristate and a colored dye, wherein the shell is soluble in one or more organic solvents.

18. A method of protecting a user comprising:
providing the article of claim 14, and
detecting a contamination of the article upon a change of color due to release of the dye from the microcapsules.
